(19) United States
(12) Patent Application Publication
(10) Pub. No.: US 2025/0096478 A1
(43) Pub. Date: Mar. 20, 2025

(54) REFLECTOR ASSEMBLIES FOR ACTIVE ANTENNA UNITS AND ACTIVE ANTENNA UNITS AND BASE STATION ANTENNAS WITH THE REFLECTOR ASSEMBLIES

(71) Applicant: Outdoor Wireless Networks LLC, Claremont, NC (US)

(72) Inventors: Fan He, Suzhou (CN); Ligang Wu, Suzhou (CN); Ning Liu, Suzhou (CN); Fusheng Lv, Suzhou (CN); Zhanming Zhang, Suzhou (CN)

(21) Appl. No.: 18/729,312

(22) PCT Filed: Sep. 15, 2022
(86) PCT No.: PCT/CN2022/118993

§ 371 Date: Jul. 16, 2024

(30) Foreign Application Priority Data
Mar. 8, 2022 (CN) 202210217965.0
Jun. 29, 2022 (CN) 202210755280.1

(51) Int. Cl. H01Q 15/14; H01Q 21/06

(52) U.S. Cl. CPC H01Q 15/14; H01Q 21/068

(57) ABSTRACT

Reflector assemblies suitable for active antenna units and/or base station antennas are provided that include a reflector body and a lip extending about a perimeter of the reflector body. The reflector body can optionally include a plurality of fin structures extending about a least part of a perimeter of the reflector body. The fin structures and/or side walls of the reflector body can be directly exposed to environmental conditions during use. The fin structures, where used, can be shaped channel members that can be formed of sheet metal or provided as separate extruded or die cast members that can be coupled to the reflector body.

### RELATED APPLICATIONS

This application claims the benefit of priority from CN Application No. 202210217965.0, filed on Mar. 8, 2022 and CN Application No. 202210755280.1, filed on Jun. 29, 2022, the entire contents of which are hereby incorporated by reference.

### BACKGROUND

The present invention generally relates to radio communications and, more particularly, to base station antennas for cellular communications systems.

Cellular communications systems are well known in the art. In a cellular communications system, a geographic area is divided into a series of regions or “cells” that are served by respective macrocell base stations. Each macrocell base station may include one or more base station antennas that are configured to provide two-way radio frequency (“RF”) communications with subscribers that are within the cell served by the base station. In many cases, each base station is divided into “sectors.” In one common configuration, a hexagonally-shaped cell is divided into three 120° sectors in the azimuth plane, and each sector is served by one or more macrocell base station antennas that have an azimuth Half Power Beamwidth (HPBW) of approximately 65°. So-called small cell base stations may be used to provide service in high-traffic areas within portions of a cell. Typically, the base station antennas are mounted on a tower or other raised structure, with the radiation patterns that are generated by the base station antennas directed outwardly.

Certain components of base station antennas can generate heat. For example, radios can generate heat. In the past, external heat sink fins have been provided in a chassis or body of the radio unit/sub-unit and in housings of base station antennas to help dissipate that generated heat. Further details of example conventional antennas can be found in co-pending WO 2019/236203 and WO 2020/072880, the contents of which are hereby incorporated by reference as if recited in full herein.

### SUMMARY

Pursuant to embodiments of the invention, fin structures coupled to reflector bodies are provided that do not require the fin structures to be integrated with a reflector body and/or a reflector primary surface.

Embodiments of the invention are directed to a reflector assembly for a base station antenna that includes: a reflector body with an outer perimeter providing a lip that extends outward from the reflector body; and a plurality of fin structures, stacked in a front to back direction, about the outer perimeter.

The reflector body can have a front surface. The lip can extend laterally and/or longitudinally behind the front surface. The plurality of fin structures can reside in front of the lip.

The reflector body can be rectangular with a pair of long sides and a pair of short sides. The lip can be provided as a plurality of lip segments that extend outward, at least one lip segment that extends outward from each of the long and short sides.

The lip can be defined by at least one fold or bend in a segment of a sheet of metal providing the reflector body.

The lip can have four lip segments. Neighboring end portions of at least first and second ones of the lip segments can be spaced apart and define an open corner space.

The reflector assembly can further include a coupling member extending across the open corner space.

At least some of the plurality of fin structures can be provided by stacked sets of U-shaped channels, oriented so that an open end of the U-shaped channels faces outwardly away from the reflector body and a closed end of the U-shaped channels abuts or is in close proximity to a side wall, a top wall or a bottom wall of the reflector body.

At least some of the plurality of fin structures can be provided by stacked sets of L-shaped channels, oriented so that a short end of the L-shaped channels abuts or is in close proximity to a side wall, a top wall or a bottom wall of the reflector body.

The reflector body can have a pair of laterally spaced apart side walls and longitudinally spaced apart top and bottom walls, the side walls, the top wall and the bottom wall surrounding a front surface of the reflector body, and wherein the side walls, the top wall and the bottom wall extend rearwardly, in front to back direction, perpendicular to and between the lip and the front surface of the reflector body.

A first subset of the plurality of fin structures can be affixed to the side walls and a second subset of the plurality of fin structures can be affixed to the top wall or the bottom wall.

At least some of the plurality of fin structures can be soldered, welded, brazed and/or riveted to one or more of a top wall, a bottom wall or a side wall of the reflector body.

The reflector body can have a plurality of apertures, at least some of which have a lateral extent that is in a range of 20-90% of a lateral extent of the reflector body.

At least some of the plurality of apertures can also have a longitudinal extent that is in a range of 10-60% of a longitudinal extent of the reflector body.

The reflector body can be provided as a frame that provides the lip. The reflector body can be configured to cooperate with one or more substrates for defining a reflector front surface behind radiating elements and in front of a radio.

At least some of the plurality of fin structures can be provided by an elongate channel member that is bendable or foldable to define a respective fin structure comprising first and second segments that are co-planar and orthogonal to each other whereby a bend forms a 90 degree bend joint, and wherein the first and second segments of the elongate channel extend in front of the lip.

The lip can extend laterally outward from and perpendicular to a right side wall and a left side wall. The lip can also extend longitudinally from and perpendicular to a top wall and a bottom wall.

At least some of the plurality of fin structures can be provided by an extruded or diecast member that is a discrete component from the reflector body.

At least some of the plurality of fin structures can have a fin surface with at least one curvilinear outer facing perimeter defining a recess configured to receive a respective fixation member.

The reflector body and the plurality of fin structures can have an anti-corrosion surface treatment such as galvanization and/or a coating or plating.

Some embodiments are directed to an active antenna unit that includes the reflector assembly as well as a radio behind the reflector assembly, a radio housing holding the radio, and radiating elements in front of the reflector assembly.

Some embodiments are directed to a base station antenna that includes the reflector assembly described herein.

Yet other embodiments are directed to a reflector assembly for a base station antenna that includes: a reflector body having a front with a perimeter and a thermally conductive fin structure that includes a plurality of stacked channel members. The stacked channel members are coupled to the reflector body and extend laterally and/or longitudinally outward from the perimeter of the reflector body.

The reflector assembly can further include a lip extending outwardly from and behind the perimeter of the front of the reflector body.

The reflector body can have/be formed of sheet metal and the lip can be formed by at least one bend in a segment of the sheet metal.

The stacked channel members can include sheet metal U-shaped or L-shaped channels.

The stacked channel members can be provided as extruded or die cast members.

The reflector assembly can also include a dielectric gasket positioned between the plurality of stacked channel members and a facing segment of the reflector body.

Other embodiments are directed to an active antenna unit for a base station antenna that includes: a reflector body with an outer perimeter providing a lip that extends outward from the reflector body; a radome coupled to and in front of the reflector body; and a radio coupled to and behind the reflector body.

The reflector body has a front surface and the lip can extend laterally and/or longitudinally behind the front surface. The reflector body can have a plurality of side wall walls extending behind the front surface that couples the front surface to the lip. In use, the side walls are directly exposed to environmental conditions.

All of the side walls can be devoid of outwardly projecting thermal fins and can define a thermal outlet for a thermal path from heat source(s) in the radio.

The reflector body can be rectangular with a pair of long sides and a pair of short sides. The lip can be provided as a plurality of lip segments that extend outward with at least one lip segment extending outward from each of the long sides and/or each of the short sides.

The lip can be defined by at least one fold or bend in a segment of a sheet of metal providing the reflector body.

The lip can have four lip segments. Neighboring end portions of at least first and second ones of the lip segments can be spaced apart and define an open corner space.

The active antenna unit can include a coupling member extending across the open corner space.

The radome can have an outer perimeter portion with an internal groove that can hold a seal member. The radome can be sealably coupled to a front surface of the reflector body.

The side walls can have a height that is in a range of about 20 mm to about 50 mm.

At least one of the side walls can have outwardly projecting thermal fins that reside in front of the lip.

The reflector body can have a primary surface that has a bend defining a lip segment that can extend forward.

The lip segment can have at least one (heat dissipation) fin structure.

The reflector body can have a primary surface that has a bend defining a lip segment that extends rearward.

The lip segment can have at least one (heat dissipation) fin structure.

The reflector body can have an environmentally exposed primary surface between the radome and the lip thereby providing a heat conduction path from the radio.

Yet other aspects of the invention are directed to an active antenna unit for a base station antenna that includes: a radome; a reflector body having a primary surface that is behind the radome with an outer perimeter providing a lip that extends outward from the radome; and a radio coupled to and behind the reflector body.

The radome can have an outer perimeter with a scallop shape. The reflector body can have a plurality of spaced apart apertures for receiving fixation members to couple the radome, the reflector body and the radio together.

The lip can have at least one lip segment that is orthogonal to the primary surface of the reflector body and can define a thermal heat dissipation pathway from the radio.

The reflector body can have an environmentally exposed primary surface between the radome and the lip thereby providing a heat conduction path from the radio.

The lip can extend forward to terminate at a plane that is substantially in line with a front surface of the radome.

The lip can define at least one heat sink structure that extends laterally outward and/or laterally inward.

The lip can define at least one heat sink structure that extends laterally outward and at least one heat sink structure that extends laterally inward.

The reflector body can include a plurality of longitudinally extending, laterally spaced apart heat sink structures that can project forward from the primary surface.

It should be noted that various aspects of the present disclosure described for one embodiment may be included in other different embodiments, even though specific description is not made for the other different embodiments. In other words, all the embodiments and/or features of any embodiment may be combined in any manner and/or combination, as long as they are not contradictory to each other.

### BRIEF DESCRIPTION OF THE DRAWINGS

FIG. 1 is a front, side perspective, partially exploded view of a reflector assembly according to embodiments of the present invention.

FIG. 2 is a front, side perspective, assembled view of the reflector assembly shown in FIG. 1.

FIG. 3 is a front, side, partially exploded view of an active antenna module with the reflector assembly shown in FIGS. 1 and 2 according to embodiments of the present invention.

FIG. 4A is front, side perspective view of another embodiment of a reflector assembly according to embodiments of the invention.

FIG. 4B is a partially exploded front perspective view of a portion of an example active antenna unit having the reflector assembly shown in FIG. 4A according to embodiments of the present invention

FIG. 4C is a greatly enlarged view of a portion of the radio and reflector assembly shown in FIG. 4B.

FIG. 5 is a greatly enlarged front, side perspective view of a corner segment of the reflector assembly shown in FIG. 2.

FIG. 6A is a front perspective view of another reflector assembly according to embodiments of the invention.

FIGS. 6B and 6C are side, perspective views of example extruded or die cast fin members comprising sets of stacked fins according to some embodiments of the present invention.

FIG. 7 is a front, side perspective, partially exploded view of another embodiment of the reflector assembly and active antenna unit according to embodiments of the present invention.

FIGS. 8A and 8B are assembled views of a reflector assembly with different metal surfaces, with FIG. 8B illustrating the reflector assembly with a surface treatment to thereby facilitate stability in harsh environmental conditions according to embodiments of the present invention.

FIGS. 9A and 9B are enlarged schematic illustrations of a plurality of heat fins and a portion of the reflector assembly and a thermally conductive gasket according to embodiments of the present invention.

FIGS. 9C and 9D are enlarged side perspective views of a corner portion of the reflector body showing an alternative embodiment thereof according to embodiments of the present invention.

FIGS. 10A-10E are enlarged schematic illustrations of example configurations of a plurality of heat fins and a portion of the reflector assembly according to embodiments of the present invention.

FIG. 11A is a schematic illustration of a fin structure that is bendable to form fins according to embodiments of the present invention.

FIG. 11B is a schematic illustration of the fin structure shown in FIG. 11A in a bent configuration providing two sides of a fin structure, e.g., side and top or side and bottom fins according to embodiments of the present invention.

FIG. 12 is a schematic illustrations of a bent fin structure that can be provided by additional bends in a starting fin structure according to embodiments of the present invention.

FIG. 13A is a top, side perspective view of another example starting fin structure with a plurality of preformed notches for bending according to embodiments of the present invention.

FIG. 13B is a front, side perspective view of the starting fin structure shown in FIG. 13A bent at a plurality of places to form a frame shaped fin structure according to embodiments of the present invention.

FIG. 13C is a front, side perspective view of the fin structure shown in FIG. 13B assembled to a reflector body according to embodiments of the present invention.

FIG. 13D is a greatly enlarged view of a corner portion of the assembly shown in FIG. 13C.

FIG. 14 is a rear perspective view of a base station antenna comprising an active antenna unit with the reflector assembly held at least partially external to the passive housing according to embodiments of the present invention.

FIG. 15 is a simplified lateral cross-section view of a base station antenna with the active antenna unit with the reflector assembly held inside the base station antenna according to embodiments of the present invention.

FIG. 16 is a lateral section, simplified schematic view of an example active antenna unit illustrating a thermal path from heat sources in a radio according to embodiments of the present invention.

FIG. 17 is a lateral section, simplified schematic view of another example active antenna unit illustrating a thermal path from heat sources in a radio according to embodiments of the present invention.

FIG. 18 is a box diagram of an example thermal flow path of an antenna according to embodiments of the present invention.

FIG. 19 is a front, side perspective view of the active antenna unit shown in FIG. 18.

FIG. 20 is an enlarged top view of the active antenna unit shown in FIG. 19.

FIG. 21 is a greatly enlarged view of a corner portion of the active antenna unit shown in FIGS. 19 and 20.

FIG. 22 is a simplified, section view of the active antenna unit shown in FIG. 20 according to embodiments of the present invention.

FIG. 23 is a partially exploded view of the active antenna unit shown in FIG. 20.

FIG. 24 is a rear, perspective, partially exploded view of the active antenna unit shown in FIG. 23.

FIG. 25 is an enlarged, exploded view of a segment of the active antenna unit shown in FIG. 23.

FIG. 26A is a front, side perspective view of another embodiment of an active antenna unit according to the present invention.

FIG. 26B is a front, side perspective view of a reflector shown in FIG. 26A.

FIG. 26C is an end (top/bottom) view thereof.

FIG. 26D is an enlarged end view of the active antenna unit shown in FIG. 26A.

FIG. 27A is a front, side perspective view of another embodiment of a reflector for an active antenna unit according to the present invention.

FIG. 27B is an end (top/bottom) view thereof.

FIG. 27C is an enlarged end view an active antenna unit with the reflector shown in FIG. 27A according to embodiments of the present invention.

FIG. 28A is a front, side perspective view of another embodiment of a reflector for an active antenna unit according to the present invention.

FIG. 28B is an end (top/bottom) view thereof.

FIG. 28C is an enlarged end view an active antenna unit with the reflector shown in FIG. 28A according to embodiments of the present invention.

FIG. 29A is a front, side perspective view of another embodiment of a reflector for an active antenna unit according to the present invention.

FIG. 29B is an end (top/bottom) view thereof.

FIG. 29C is an enlarged end view an active antenna unit with the reflector shown in FIG. 29A according to embodiments of the present invention.

FIG. 30A is a front, side perspective view of another embodiment of a reflector for an active antenna unit according to the present invention.

FIG. 30B is an end (top/bottom) view thereof.

FIG. 30C is an enlarged end view an active antenna unit with the reflector shown in FIG. 30A according to embodiments of the present invention.

FIG. 31A is an end view of another embodiment of an active antenna unit according to the present invention.

FIG. 31B is a front, side perspective view of a reflector of the active antenna unit shown in FIG. 31A.

FIG. 31C is an end (top/bottom) view of the reflector shown in FIG. 31B.

FIG. 32 is a partial end view of another embodiment of a reflector according to embodiments of the present invention.

FIG. 33 is a partial end view of another embodiment of an active antenna unit according to embodiments of the present invention.

### DETAILED DESCRIPTION

The demand for cellular communications capacity has been increasing at a high rate. As a result, the number of base station antennas has proliferated in recent years. Base station antennas are both relatively large and heavy and, as noted above, are typically mounted on antenna towers. Due to the wind loading on the antennas and the weight of the antennas and associated radios, cabling and the like, antenna towers must be built to support significant loads. This increases the cost of the antenna towers.

In the description that follows, active antenna units for base station antennas and the components thereof are described using terms that assume that the base station antennas are mounted for use on a tower with the longitudinal axis of the antenna extending along a vertical (or near vertical) axis and the front surface of the antenna mounted opposite the tower or other mounting structure pointing toward the coverage area for the antenna.

Embodiments of the present invention will now be discussed in greater detail with reference to the attached figures.

Die cast or extruded reflector structures with integrated heat sinks in an active antenna unit are described in co-pending PCT/CN2021/116847, the contents of which are hereby incorporated by reference as if recited in full herein. However, integrating heat sinks into the reflector structure may require relatively expensive tooling and/or manufacturing techniques. The present inventive concept provides alternative reflector assembly configurations that can reduce cost and/or weight of the reflector structure.

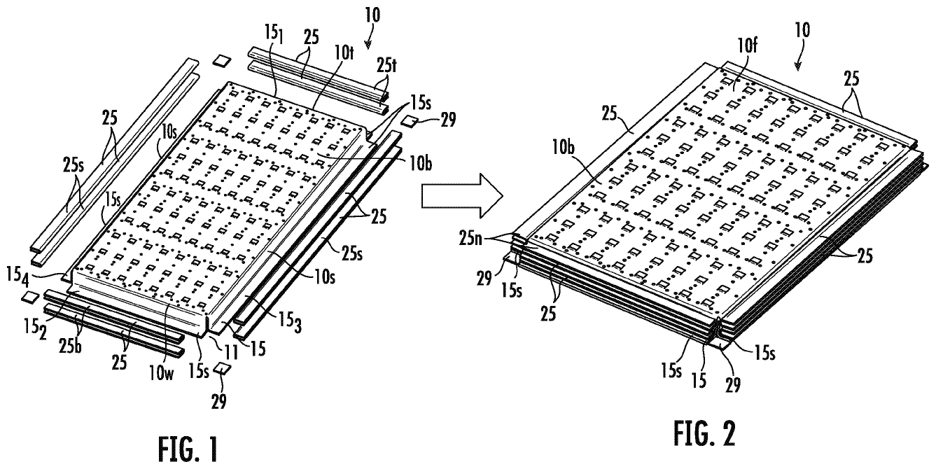

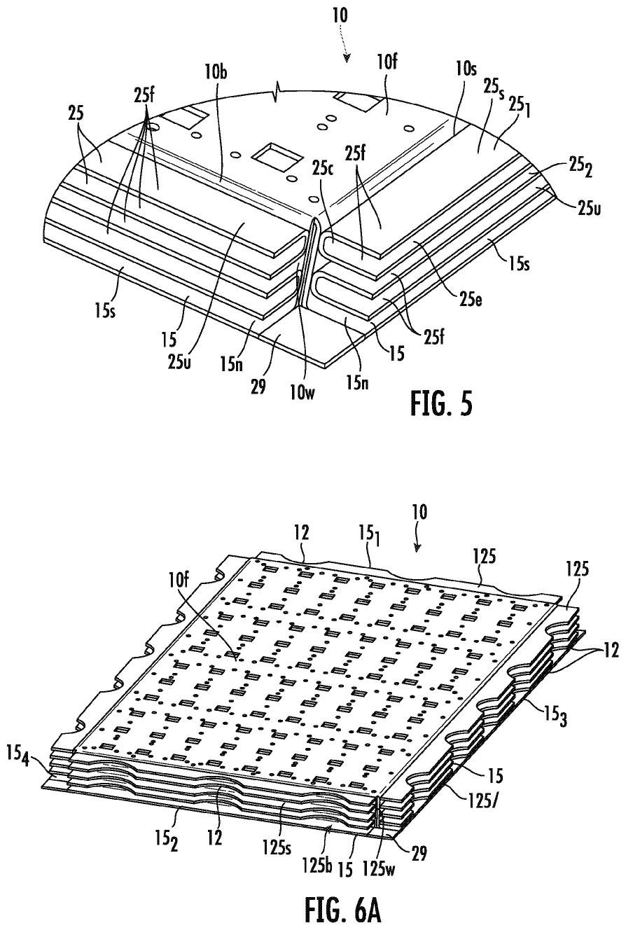

Referring to FIGS. 1, 2, and 5, a reflector assembly 10 with a reflector body 10b with a lip 15 extending outward from the reflector body 10b is shown. The lip 15 can have first 151 and second 152 lip segments 15s that extend longitudinally from and perpendicular to a top wall 10t and a bottom wall 10w, respectively. The lip 15 can have third 153 and fourth 154 lip segments 15s and can extend laterally outward from right and left side walls 10s, respectively. As shown, the lip 15 is perpendicular to each of the right and left side walls 10s and the bottom and top walls 10w, 10t. A plurality of fin structures 25 that are thermally conductive heat dissipation fins can reside in front of the lip 15. The fin structures 25 can be provided with a plurality of fin surfaces 25f, that can be provided as parallel planar fins surfaces, and that can reside in front of the lip 15, typically flush with or behind a front surface of the reflector body 10b.

In some embodiments, there are a plurality of fin surfaces 25f, typically 3-10, more typically 3-6, extending from all four sides (right and left side and top and bottom sides) of the reflector body 10b. However, the fin structures 25 may be provided on a subset of the sides, such as two or three sides rather than all four as shown.

The fin surfaces 25f can extend out a distance from the primary reflector body 10b that is equal to, greater than, or less than a distance that the lip 15 extends from the reflector body 10b. Different fin surfaces 25f can have different extension lengths.

The reflector body 10b can be formed of shaped sheet metal, such as metal comprising or defined by aluminum. The lip 15 can be formed by bending segments of the sheet metal providing the reflector body 10b. The lip 15 can have open corner spaces 11 between adjacent end portions of neighboring 15n lip segments 15s.

In some embodiments, at least some of the fin structures 25 can be formed of metal, such as sheet metal.

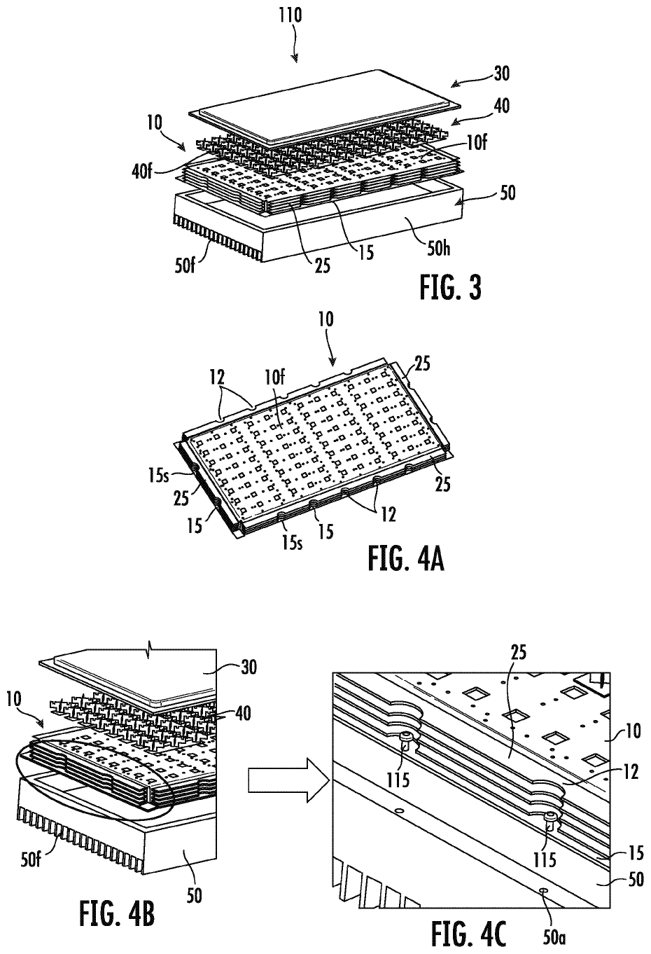

The reflector assembly 10 can include at least one coupling member 29 extending between and over and/or behind a corresponding open corner 11. The coupling member 29 may be square or rectangular but other shapes may be used. As shown, there are four coupling members 29 at four corners and the coupling members 29 can cooperate with the lip 15 to define a closed reflector perimeter surface to isolate the radio 50 from the radiating elements 40 (FIG. 3) and/or to provide a water resistant or waterproof barrier.

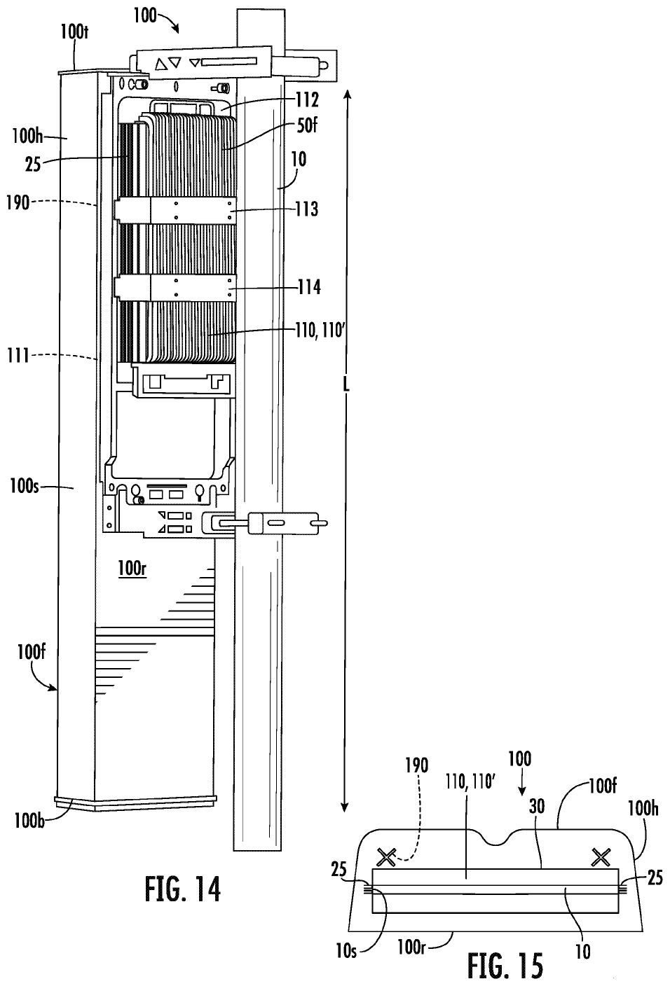

The (primary) reflector body 10b can have a rectangular shape with a pair of long sides and a pair of short sides surrounding a front surface 10f. In operative position (FIG. 14), the long sides can extend longitudinally, and the short sides can extend laterally.

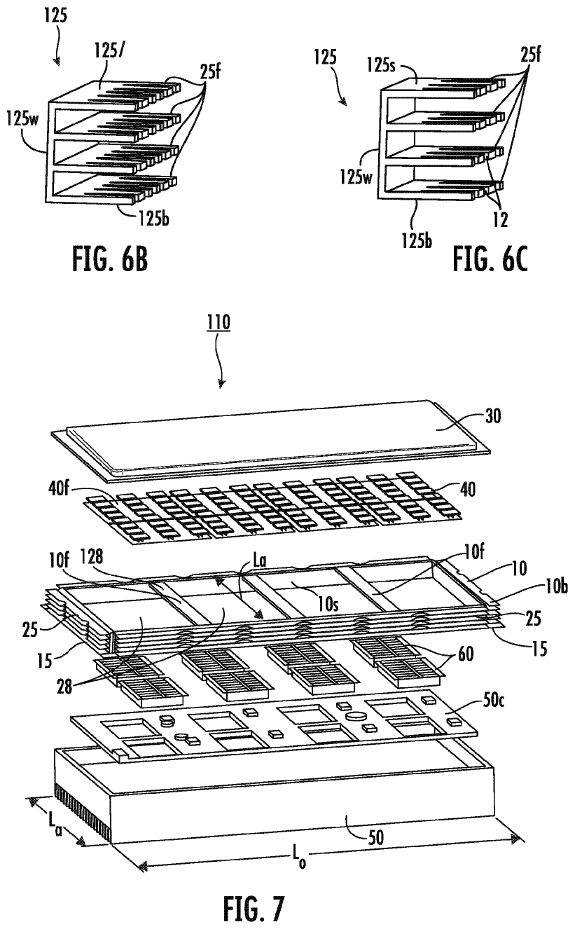

The fin structures 25 can be provided by cooperating fin structures that are attached to at least one of a side wall 10s, a top wall 10t or a bottom wall 10w of the reflector body 10b. The fin structures 25 can be metal-stamped or other metal shaped and formed members and can be separate components from the reflector body 10b. The fin structures 25 are not required to be die cast or extruded fins but may be so configured (FIGS. 6A-6C).

The fin structures 25 can be attached to the reflector body 10b using any suitable attachment configuration including, for example, rivets, welds, solder joints, brazing, chemical bonding and the like. For soldering or welding, one or more spaced apart solder or weld joints may be provided along an outer facing surface of one or all of each side wall or each end wall 10t, 10w and each facing fin structure 25. For riveting, a TOX® riveting process may be used to facilitate a suitable seal configuration. The TOX riveting process is a cold joining process also known as “TOX®-Clinching” where during clinching or press joining, the sheet metals to be joined are connected force-and positive-locked with each other in a continuous forming process.

In some embodiments, subsets of the fin structures 25 can be attached together and attached to the lip 15 without requiring soldering, welding or riveting to the side wall 10s, the top wall 10t or the bottom wall 10w. For example, the cooperating components can be clamped together using suitable configurations and/or frictional engagement and the like. In yet other embodiments, the fin structures 25 can be attached to the reflector body in other manners and the reflector body may be provided without the lip 25.

Referring to FIGS. 1, 2, 5, and 10A, for example, at least some of the plurality of fin structures 25 are provided by stacked sets 25₁, 25₂ of U-shaped channels 25u, oriented so that an open end 25e of the U-shaped channels 25u faces outwardly away from the reflector body 10b and a closed end 25c of the U-shaped channels 25u abuts or is in close proximity to a side wall 10s, a top wall 10t or a bottom wall 10w of the reflector body 10b. It will be appreciated that the term “U-shaped” is used broadly herein, and encompasses, for example, channels where the side walls and bottom walls meet at sharp angles (e.g., 90° angles) as opposed to rounded joints, and encompasses structures in which the sidewalls do not extend the same length outwardly.

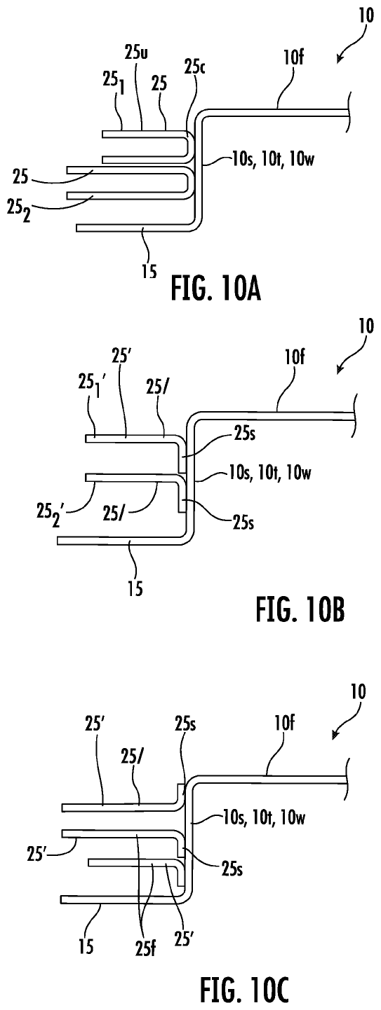

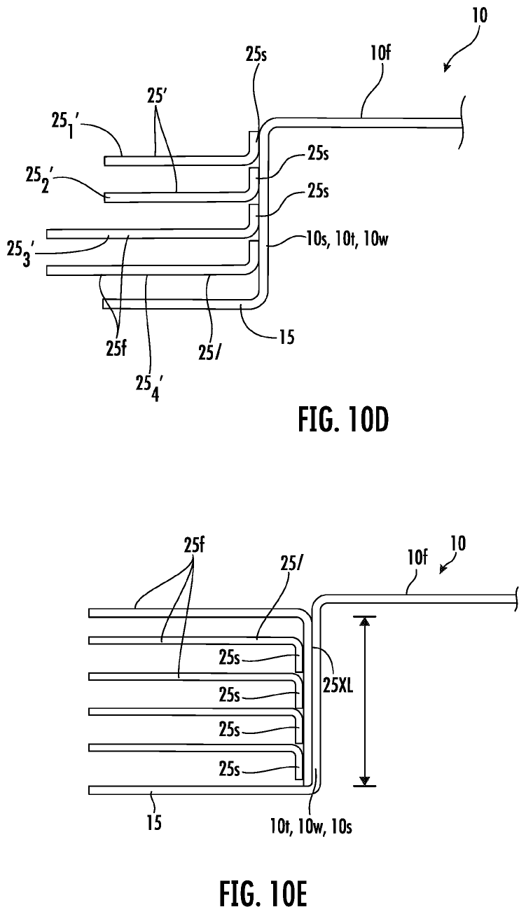

As shown in FIGS. 10B-10E, at least some of the plurality of fin structures 25 are provided by stacked sets of L-shaped channels 25l, oriented so that a short end 25s of the L-shaped channels abuts, or is in close proximity to, a side wall 10s, a top wall 10t or a bottom wall 10w of the reflector body 10b, and the long end of the L-shaped channel extends outwardly from the short end.

Referring to FIG. 3, the reflector assembly 10 can be provided in an active antenna unit 110. The active antenna unit 110 can comprise a radome 30 and radiating elements 40 projecting forward of feed boards 40f. The reflector assembly 10 resides behind the radiating elements 40 and in front of a radio housing 50h that contains a radio 50.

The radiating elements 40 can be configured as a massive Multiple Input Multiple Output (mMIMO) array that can operate in a 3-4 GHz frequency range, in some embodiments. The radio housing 50h can include rearwardly extending thermally/heat conductive fins 50f.

It is noted that the term “active antenna unit” is interchangeably referred to herein as an “active antenna module”. Active antenna modules may be deployed as standalone base station antennas or may be deployed in base station antennas configured as larger antenna structures that include additional active antenna modules and/or conventional “passive” antenna arrays that may be connected to radios that are external to the antenna structures.

Referring to FIGS. 4A-4C, at least some of the fin structures 25 of the reflector assembly 10 can have recesses 12. The recesses 12 can have curvilinear, e.g., semi-circular or arcuate shapes. Other recess shapes may be used. The recesses 12 can be provided as a scalloped cut out pattern over a length of a respective surface 25f of a fin structure 25. The recesses 12 can be configured to receive a fixation member 115 (e.g., a screw) to couple the reflector assembly 10 to the radio housing 50h. The radio housing 50h can comprise cooperating apertures 50a that receive the fixation members 115.

Referring to FIGS. 6A-6C, at least some of the fin structures 25 can be provided as stacked planar fin surfaces 25f provided by a die cast or extruded body 125. The die cast or extruded body 125 can comprise an inner wall 125w that can be coupled to the reflector body 10b, e.g., to one of a side wall 10s, a top wall 10t or a bottom wall 10w. In some embodiments, the back wall 125b can be coupled to the lip 15 and/or reside against the lip 15. In some embodiments, the inner wall 125w and the back wall 125b can be coupled to respective adjacent surfaces of the reflector body 10b (e.g., side wall 10s and lip 15). FIGS. 6B and 6C illustrate that the die cast or extruded body 125 can be provided in different lengths, e.g., a short side length 125s and a long side length 125l, for a short side and longer side of the reflector body 10b, respectively.

As shown in FIG. 7, the reflector body 10b can have a frame configuration whereby the front surface 10f has a front perimeter with cut outs and/or apertures 28 that extend between the side walls 10s and that have a lateral extent La that is in a range of 20-99% of a lateral extent La of the reflector body 10b. At least some of the plurality of apertures 28 can also have a longitudinal extent Lo that is in a range of 10-90% of a longitudinal extent Lo of the reflector body 10b.

One or more bridges 128 can provide at least part of the front surface 10f and can extend between adjacent/neighboring apertures 28.

The apertures 28 can reside in front of one or more cavity filters 60 and behind feed boards 40f with radiating elements 40. The front surface 10f can surround a perimeter of the feed boards 40f and the cavity filters 60 can have front surfaces that cooperate with the reflector body 10b to provide reflective surfaces to provide a reflector function. The cavity filters 60 can be resonant cavity filters as is well known to those of skill in the art. The radio can have a metal cover 50c.

The cavity filters 60 can cooperate with the radio cover 50c, and the reflector body 10b to define a reflector for the radiating elements 40 thus eliminating the need for a separate reflector behind the feed boards 40f and in front of the cavity filters 60 as in conventional active antenna units.

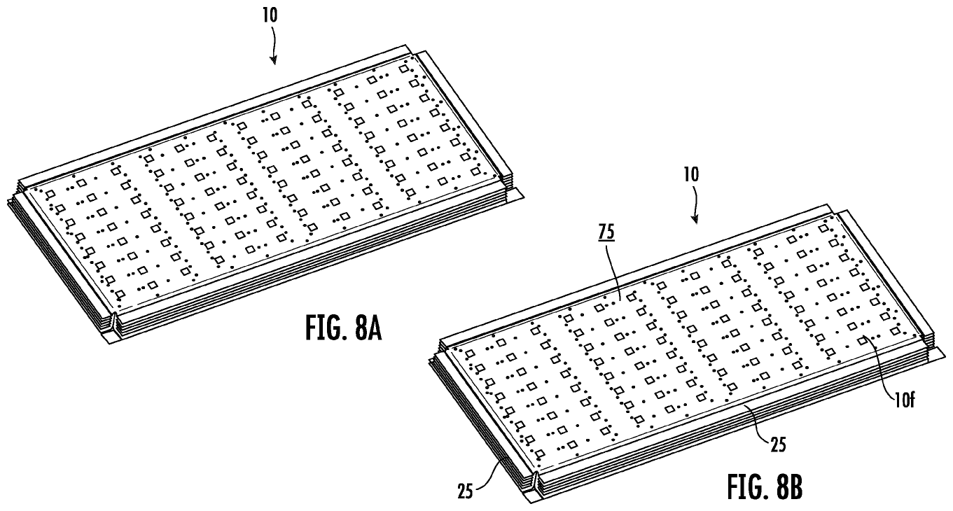

Referring to FIGS. 8A and 8B, the reflector assembly 10 can have a surface treatment 75 whereby surfaces of the reflector body 10b and fin structures 25 are manufactured to improve survival in harsh environments such as salt, fog, smog and other environmental exposures prior to assembly to the radiating elements 40. The surface treatment can comprise plating, coating and/or galvanization of the metal(s) to provide an anti-corrosion surface.

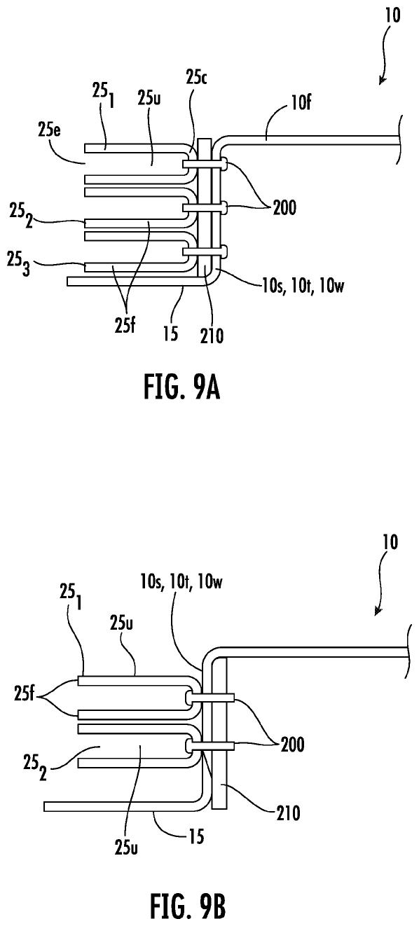

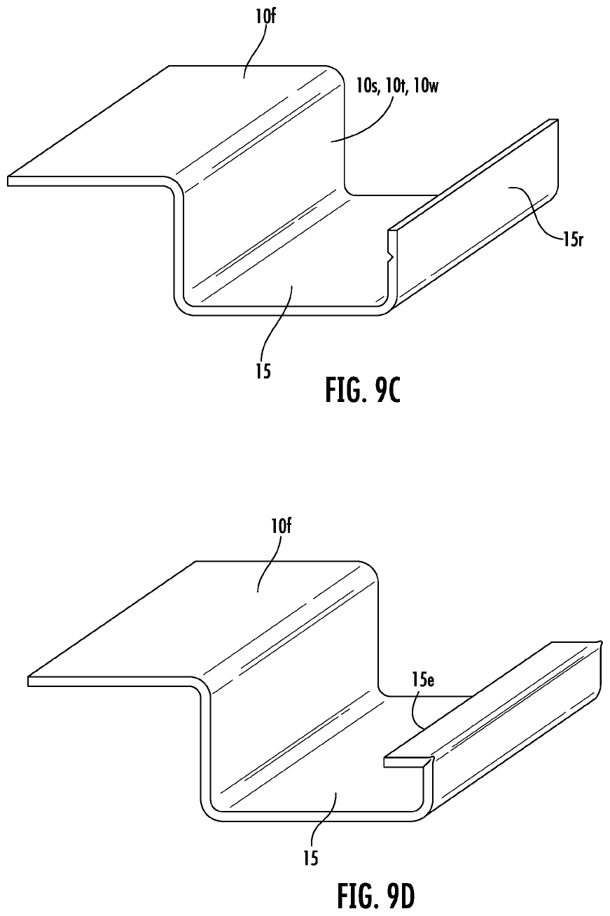

FIG. 9A illustrates that the reflector assembly 10 can comprise rivets 200 that extend through a wall 10t, 10w, 10s of the reflector body 10b and into a wall provided by a closed end 25e of the U-shaped channel 25u. The rivet 200 can also extend through a dielectric gasket 210 positioned between the reflector body 10 and the U-shaped channel 25u. In some embodiments, the dielectric gasket 210 may be formed of a thermally conductive material. FIG. 9B illustrates a dielectric gasket 210 positioned on an interior surface of a wall 10t, 10w, 10s. Where used, both an internal and external placed gasket 210 may also be used together in some embodiments (not shown).

The dielectric gasket 210 may reduce the risk that the interface between the wall 10t, 10w, 10s and a corresponding fin structure 25, 25′, 125 (shown by way of example with a U-shaped channels 25u) may act as a source of passive intermodulation distortion.

FIG. 9A also illustrates the use of three fin structures 25₁, 25₂, 25₃ providing 6 fin surfaces 25f defined by three stacked U-shaped channels 25u.

FIG. 9C illustrates that the lip 15 can have a front facing end 15e that projects forward of a primary surface 15p of the lip 15. In some embodiments a segment of the sheet of metal can be double bent to provide the lip 15 and the front facing end 15e. Sets of the fin structures can be slidably received by the lip 15, inside the front facing end 15e and the reflector body 10b thereby facilitating ease of assembly/alignment.

In some embodiments, as shown in FIG. 9D, the front facing end 15e can itself be bent inwardly to provide a clamping surface against the fin structure.

FIGS. 10A-10D show examples of a reflector assembly 10 with different arrangements and configurations of fin structures 25, 25′. FIGS. 10B-10D show fin structures 25′ with L-shaped channels 25l with the short ends 25s abutting, or positioned in close proximity to, the reflector body 10b (e.g., the wall 10s, 10t or 10w).

The term “close proximity” refers to a position of 0-1 mm from the adjacent wall, e.g., bottom wall 10w, top wall 10t or side wall 10s to facilitate conductive heat transfer. This distance can vary if a dielectric gasket is positioned between the components so that the fin structure 25, 25′, 125 and reflector body 10b abuts the dielectric gasket and the close proximity dimension increases by a width of the dielectric gasket.

FIGS. 10A and 10D illustrate that different fin surfaces 25f can have different lengths and some can be longer than the lip 15. Others can be shorter than the lip 15 or have the same length.

FIGS. 10B, 10C and 10D illustrate different orientations of the short side 25s of the L-shaped channel 25l that faces the wall 10s, 10t, or 10w of the reflector body 10b. FIG. 10D illustrates four L-shaped channels 25l, 25₁′, 25₂′, 25₃′, 25₄′. FIG. 10C illustrates three fin surfaces 25f and FIG. 10D illustrates four fin surfaces 25f.

FIG. 10E illustrates that the fin structures 25 can be provided with an L-shaped channel 25l having an extra-long 25xl short side 25s that can be coupled to one or more other short sides 25s of other channel members such as L-shaped channel members 25l (or even U-shaped channel members). Thus, the fin structure 25 can provide a nested configuration of L-shaped channels 25l, with one “L” having an extra-long 25xl short side that other short sides 25s nest into and can be attached to. This configuration can allow the fin structures 25 to be pre-assembled together and then attached as a unit to the reflector body 10b.

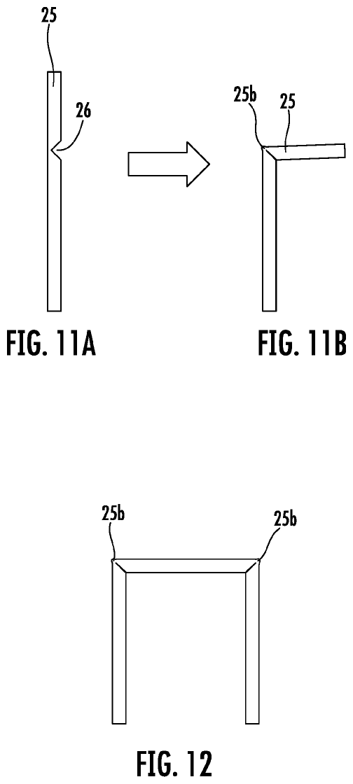

Turning now to FIGS. 11A-11B, the fin structure can be provided by bending a channel structure at least one time. FIG. 11A illustrates a starting fin structure 25 with at least one notch 26 defining a bend region 25b. FIG. 11B illustrates the resulting fin structure whereby first and second fin structure segments of the fin structure for the reflector assembly 10 are co-planar or parallel to each other and oriented at 90 degrees from each other and can couple to two sides of a reflector body 10b.

FIG. 12 illustrates a three-sided fin structure with two bend segments 25b forming first and second fin sides that are co-planar and the first and second segments are at 90 degrees from each other whereby a respective bend can define a 90 degree bend joint for neighboring bend segments (which will include two notches 26 in the starting fin structure of FIG. 11A).

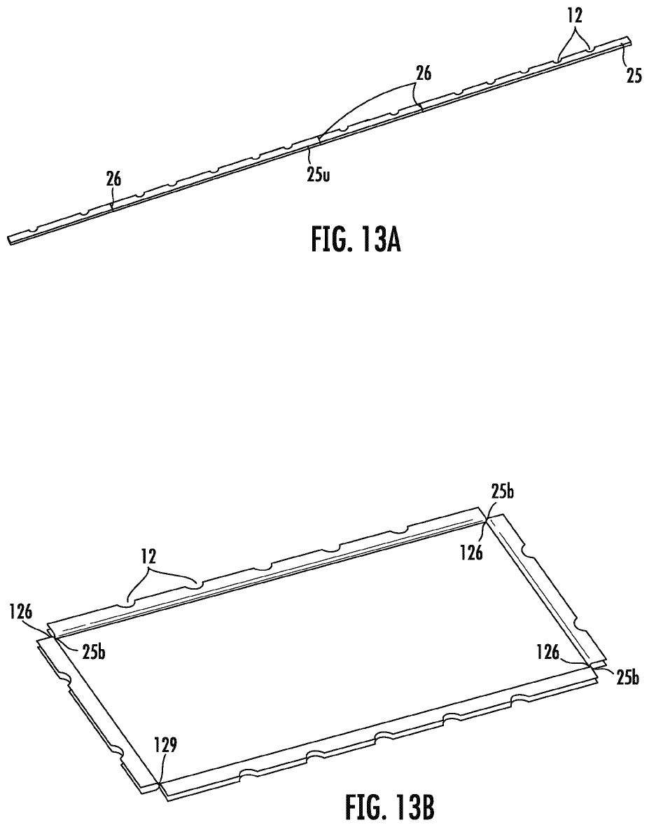

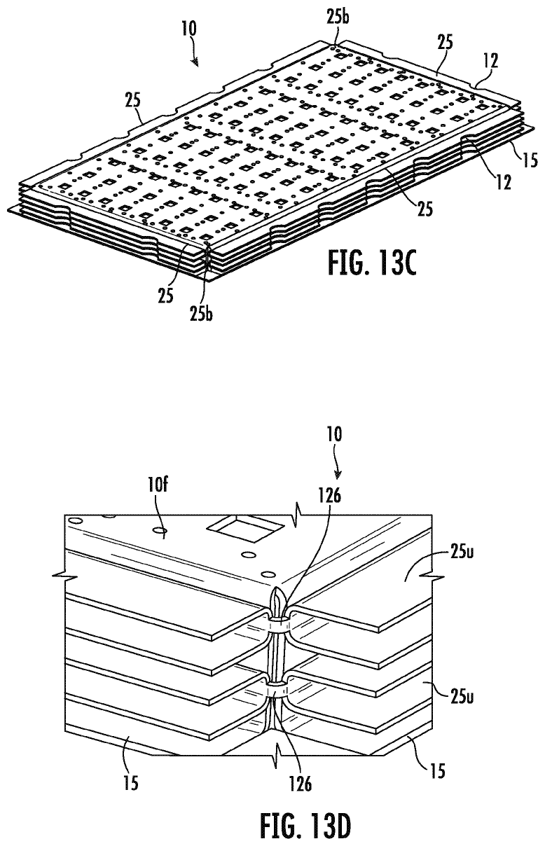

Referring to FIGS. 13A-13D, the starting fin structure can be configured to form a four-sided “frame” shaped fin structure with three bend segments (which will include three notches 26 in the starting fin structure). The notches 26 can be pre-formed or made serially as each successive bend 25b is made or may be made in a starting piece at defined spaced apart locations. The notch segment 26 can form a bridge 126 connecting and extending between bent sides of the folded/bent fin structure. One corner 129 can be formed by free ends of the channel member that meet or are closely spaced after the frame fin structure is formed.

Using multi-sided folded/bent fin channel structure, particularly, a two-sided, a three-sided, or a four-sided bent channel fin structure may provide increased rigidity to the reflector body 10b over single sided fin structures and may allow the use of a thinner reflector body 10b.

The active antenna unit 110 with the radio 50 can be configured as a 5G module in some embodiments. With the introduction of fifth generation (“5G”) cellular technologies, base station antennas are now routinely being deployed that have active beamforming capabilities. Active beamforming refers to transmitting RF signals through a multi-column array of radiating elements in which the relative amplitudes and phases of the sub-components of an RF signal that are transmitted (or received) through the different radiating elements of the array are adjusted so that the radiation patterns that are formed by the individual radiating elements constructively combine in one or more desired directions to form narrower antenna beams that have higher gain. With active beamforming, the shape and pointing direction of the antenna beams generated by the multi-column array may, for example, be changed on a time slot-by-time slot basis of a time division duplex (“TDD”) multiple access scheme. Moreover, different antenna beams can be generated simultaneously on the same frequency resource in a multi-user MIMO scenario. More sophisticated active beamforming schemes can apply different beams to different physical resource blocks that are a combination of time and frequency resources by applying the beam vector in the digital domain. Base station antennas that have active beamforming capabilities are often referred to as active antennas. When the multi-column array includes a large number of columns of radiating elements (e.g., sixteen or more), the array is often referred to as a massive MIMO array. A module that includes a multi-column array of radiating elements and associated RF circuitry (and perhaps baseband circuitry) that implement an active antenna is referred to herein as an active antenna module.

Referring to FIG. 14, a base station antenna 100 according to some embodiments is shown. The base station antenna 100 includes a passive antenna assembly 190 with a plurality of internal linear arrays 111 of radiating elements arranged in a plurality of laterally spaced apart and adjacent longitudinally extending columns between a top 100t and a bottom 100b of the base station antenna 100. In an example embodiment, there are eight columns of linear arrays 111 of radiating elements.

The active antenna unit 110 can be held against a rear 100r of a housing 100h of the base station antenna 100 comprising the passive antenna assembly with a bracket assembly 112 having first and second laterally extending spaced apart brackets 113, 114. The housing 100h has a front surface 100f defining a radome and sides 100s and a rear 100r. The bracket assembly 112 can also mount the base station antenna housing 100h with the active antenna unit 110 to a target structure such as a pole 10.

FIG. 15 illustrates another embodiment of a base station antenna 100 with a housing 100h comprising a passive antenna assembly 190 sized and configured to hold the active antenna unit 110 at least partially internally thereof. In some embodiments, the reflector assembly 10 can be held at least partially inside the base station antenna housing 100h without requiring any or all the components of the active antenna unit 110.

The base station antenna 100 can include one or more arrays of low-band radiating elements, one or more arrays of mid-band radiating elements, and one or more arrays of high-band radiating elements. The radiating elements may each be dual-polarized radiating elements. Further details of radiating elements can be found in co-pending WO 2019/236203 and WO 2020/072880, the contents of which are hereby incorporated by reference as if recited in full herein. For further details regarding example active antenna modules and base station antenna housings with passive antenna assemblies, see, co-pending U.S. patent application Ser. No. 17/209,562 and corresponding PCT Patent Application Serial Number PCT/US2021/023617, the contents of which are hereby incorporated by reference as if recited in full herein.

The linear arrays (of the active antenna unit 110) and/or 111 of the passive antenna assembly 190, can be provided as low, mid or high band radiating element. The high-band radiating elements may be configured to transmit and receive signals in the 3.3-4.2 GHz frequency band or a portion thereof and/or in the 5.1-5.8 GHz frequency band or a portion thereof. The mid-band radiating elements may be configured to transmit and receive signals in, for example, the 1.427-2.690 GHz frequency band or a portion thereof. The low-band radiating elements may be configured to transmit and receive signals in, for example, the 0.616-0.960 GHz frequency band or a portion thereof.

It will be appreciated that other types of radiating elements may be used, that more or fewer linear arrays may be included in the antenna, that the number of radiating elements per array may be varied, and that planar arrays or staggered linear arrays may be used instead of the “straight” linear arrays illustrated in the figures in other embodiments.

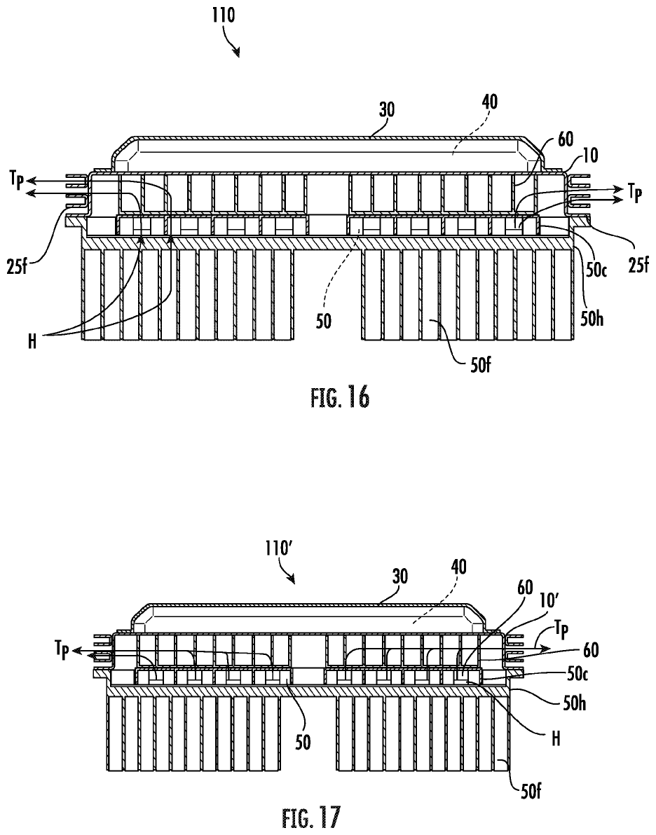

FIG. 16 illustrates an example thermal path Tp of heat from heat sources H in the radio 50. In FIG. 16, the thermal path Tp includes the fins 25f coupled to the reflector sides 10s.

FIG. 17 illustrates the thermal path Tp can be directly out of the reflector side walls 10s without requiring fins 25f. In this embodiment, the reflector side walls 10s are directly exposed to environmental conditions/air and heat flows out of the active antenna unit 110 from the radio 50 through the side walls 10s.

FIG. 18 is a block diagram of the thermal path Tp shown in FIGS. 16 and 17. Heat from heat source(s) H travels from the radio, through a cover 50c on the radio 50 between radio circuitry in the radio 50 and filter(s) 60. The filter(s) 60 can be resonant cavity filters as is known to those of skill in the art. The cover 50c may be provided by a rear surface of the filter(s) 60 or by a separate cover and may be metal.

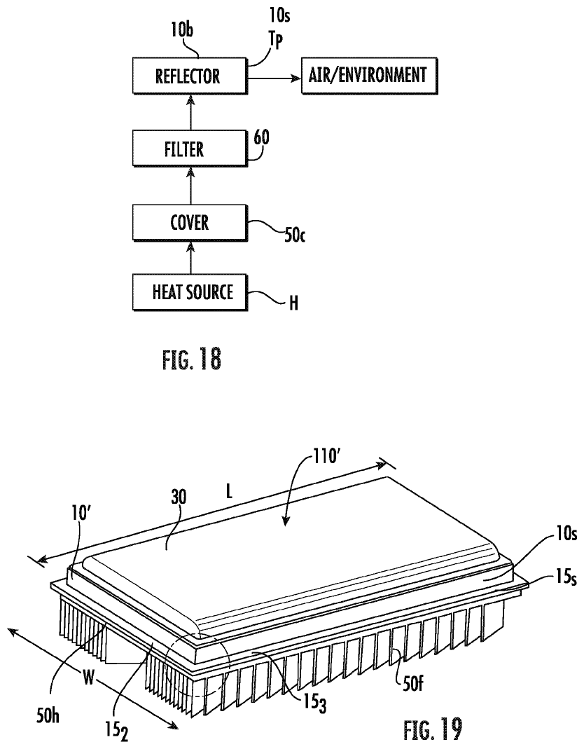

Referring to FIGS. 19-21, the active antenna unit 110′ is similar to that shown FIGS. 1-16 but the reflector body 10b has side walls 10s that extend between the radome 30 and radio 50 that are directly exposed to environmental conditions/air. The side walls 10s can have a lip 15 with neighboring lip segments 15s leaving open spaces therebetween at corners of the reflector body facing the radio 50.

As discussed above, the reflector assembly 10′ can include at least one coupling member 29 extending between and over and/or behind a corresponding open corner 11. The coupling member 29 may be square or rectangular but other shapes may be used. As shown, there are four coupling members 29 at four corners and the coupling members 29 can cooperate with the lip 15 to define a closed reflector perimeter surface to isolate the radio 50 from the radiating elements 40 (FIG. 3) and/or to provide a water resistant or waterproof barrier. The coupling members 29 can be metal and can be welded, brazed and/or adhesively attached to the neighboring lip segments 15s.

The radome 30 can be a polymeric or copolymeric material. The radio housing 50h and reflector body 10b and lip 15 can be metal.

Referring to FIG. 21, the bend between different neighboring surfaces 10n of the side walls 10s can be welded, brazed or otherwise sealed together.

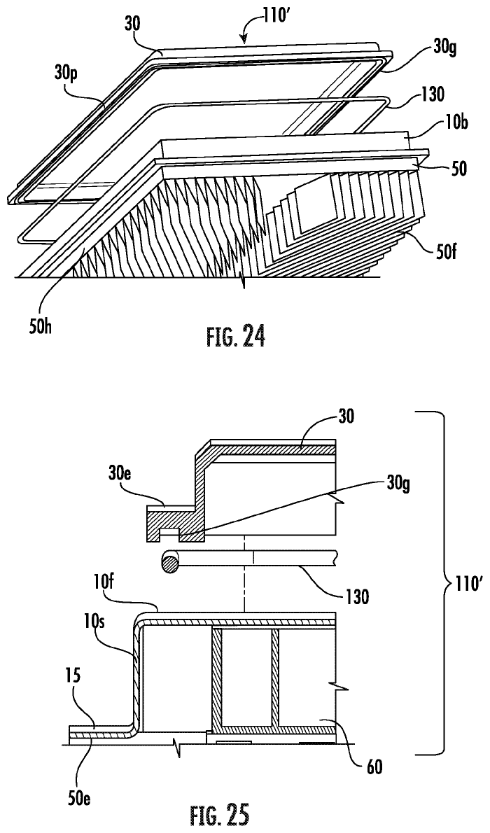

Referring to FIGS. 22-25, the radome 30 of the active antenna unit 110′ can be sealably attached to a front surface 10f of the reflector body 10b. FIG. 22 shows that the radome 30 can include an internal groove 30g for receiving a seal member 130. The internal groove can be on an outer perimeter portion 30p of the radome 30. The outer perimeter portion 30p of the radome 30 can have an external surface 30e that is planar. Attachment members 230 (typically on each side) can extend through the radome 30 and into the front surface 10f of the reflector body 10b to attach the components together and provide a water-resistant seal.

The radio housing 50h can be sealably attached to the lip 15 of the reflector body 10b. One or both components may include a seal member, such as a gasket or O-ring, that can facilitate a water-resistant seal therebetween. The radio housing 50h can have an outer perimeter with an outwardly projecting planar edge 50e that surrounds a recess 50r of the housing 50h and abuts a primary surface of the lip 15. The cover 50c can reside in the recess 50r. The cavity filters 60 can reside in front of the radio 50 at least partially inside the reflector body 10b.

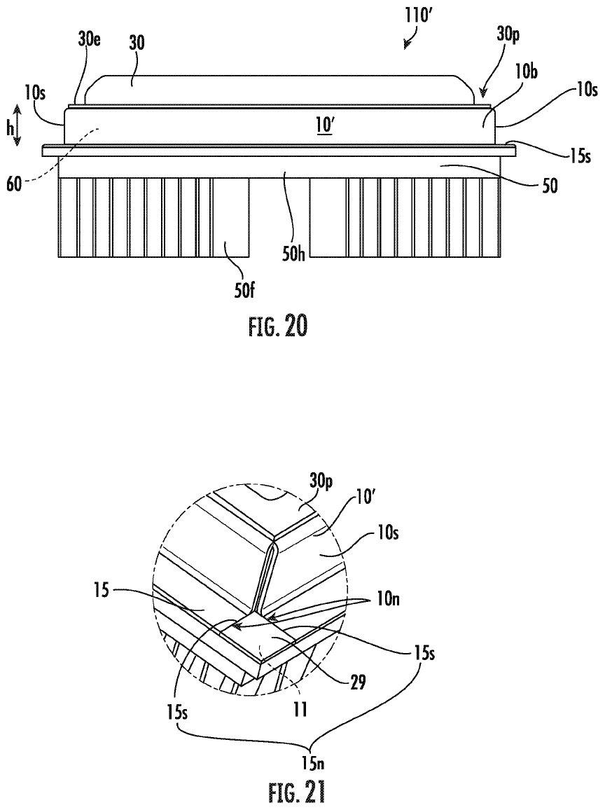

The side walls 10s of the reflector body 10b can have a height “h” that is typically in a low-profile range of about 20-60 mm, such as about 30-50 mm, e.g., about 38 mm, in some embodiments. The lip 15 can project outward from the side walls 10s a distance that is less than the height h of the side walls 10 (the height measured in a front-back direction as shown in FIG. 20). The lip 15 can project outward from the side walls 10s a distance that is the same or even greater than the height of the side walls 10s.

The long side of the reflector body 10b can have lips 15 and side walls 10s that can have a length “L” that extends longitudinally and that is greater than the width/lateral extent “W” of the lips 15 on the short side of the reflector body 10b, i.e., at the top and bottom thereof. In some embodiments, the long side lips 15 and side walls 10s are 1.5 to three times the width W. Different side walls 10s can have different size lips 15 (not shown).

The radio fins 50f can have an outwardly projecting extent that is greater than the outwardly projecting extent of the fins 25f of the reflector 10, typically 2-20 times greater, where used. The radio fins 50f can have an outwardly projecting extent that is greater than the height “h” of the reflector side walls 10s.

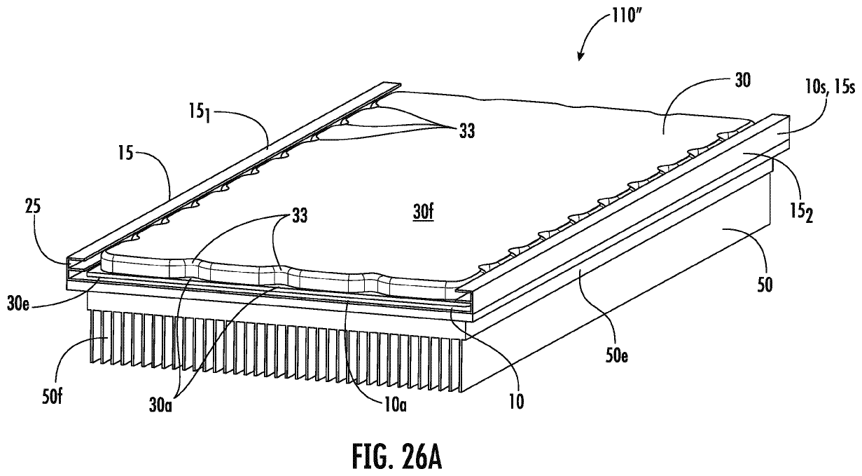

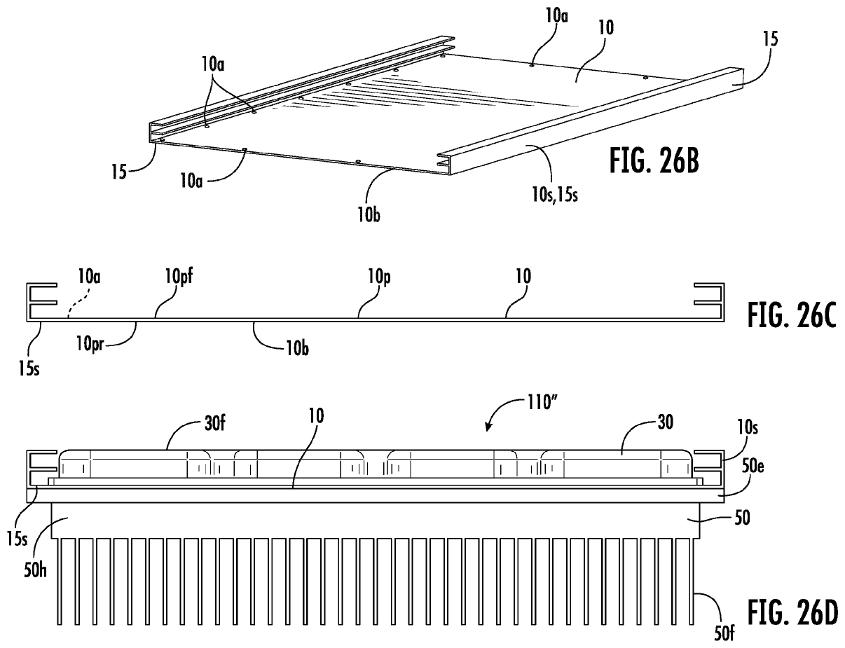

Referring to FIGS. 26A-33, other embodiments of an active antenna unit 110″ with a reflector 10 between a radome 30 and a radio 50 is shown. The reflector 10 can have a primary surface 10p that is behind the radome 30 and laterally outer end segments can be bent or formed to extend in a forward direction and/or a rearward direction relative to the radome 30. The reflector 10 is not required to have sidewalls 10s that extend rearward, perpendicular to and between the primary surface 10p and a lip 15 that can be provided as one or more lip segments 15s, allowing for a reduced height (front to back) dimension of the active antenna unit 110″.

As discussed before with respect to other embodiments, the reflector assembly 10 has a reflector body 10b with at least one lip segment 15s extending laterally outward from the reflector body 10b and laterally outward behind the radome 30. The lip segment 15s can have first 151 and second 152 lip segments 15s that extend longitudinally and laterally outward. The lip segments 15s can extend only two long sides as shown but may optionally also have third and fourth lip segments 15s that can extend laterally outward from the reflector body 10b at shorter top and bottom sides thereof and of the radome 30, respectively.

As shown, the reflector body 10b can have a primary planar surface 10p that is behind the radome 30 and from which radiating elements 40 (FIG. 4B) can project forwardly from. The reflector body 10b can have spaced apart apertures 10a arranged in a longitudinal direction and in a lateral direction. The apertures 10a can be used to couple the reflector body 10b to the radome 30 and the radio 50.

The radome 30 can have an outer perimeter with a scalloped pattern 33 aligned with apertures 30a for receiving fixation members 230 (FIG. 22), such as pins or screws and the like to couple the radome 30, the reflector body 10b and the radio 50 together.

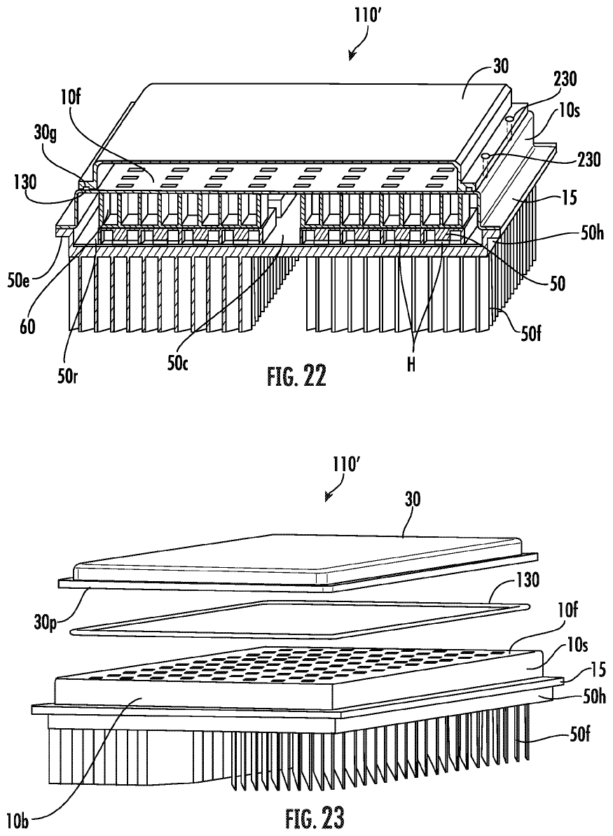

The radio housing 50h can be sealably attached to a rear 10pr of the primary surface 10p of the reflector body 10b. An outer perimeter edge segment 30e can abut the primary surface of the reflector body 10b. The radome 30 can be sealably attached to a front 10pf of the primary surface 10p of the reflector body 10b. One or both components may include a seal member, such as a gasket or O-ring 130 (FIG. 23), that can facilitate a water-resistant seal therebetween.

The radio housing 50h can have an outer perimeter with an outwardly projecting planar edge 50e that surrounds a recess 50r (FIG. 22) of the housing 50h and abuts the primary surface 10p of the reflector 10. Cavity filters 60 (FIG. 7) can reside in front of the radio 50 and behind the reflector body 10b.

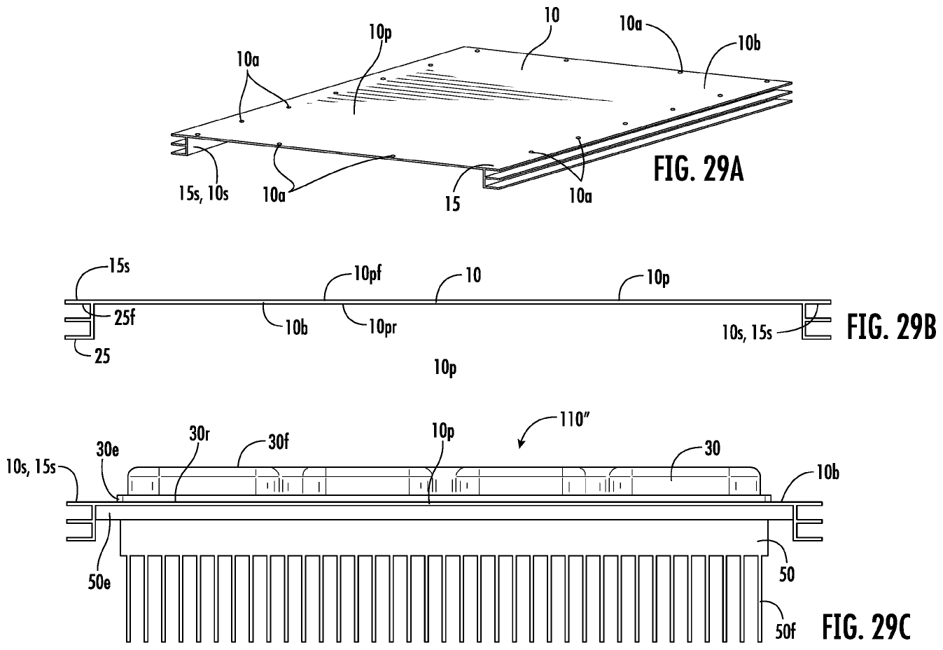

As shown in FIG. 26A-26D and 29A-29C, 30A-30C, the lip segments 15s can provide or support a plurality of fin structures 25 that are thermally conductive heat dissipation fins. Although shown as three parallel fin structures that turn laterally inward to face the radome 30, the fin structures 25 can be provided as one, two or more than three fin structures. One or more of the fin structures 25 may extend laterally outward to face away from the radome 30 (not shown).

FIG. 26A-26D show the fins 25 can reside in front of the lip segment 15 and the most frontward fin 25f can be at a front-to-back position that is substantially flush with the front surface 30f of the radome 30. The term “substantially flush” means+/−0.1 mm-5 mm. Thus, the lip 15 (with or without fin structures 25) can extend forward to terminate at a plane that is substantially in line with a front surface 30f of the radome 30.

FIGS. 29A-29C show the fins 25 can reside behind the lip 15 and the most frontward fin 25f can be defined by the lip segment 15s of the reflector body 10b and can reside behind the radome 30. Although shown as three parallel fin structures that turn laterally outward to face away from the radome 30, the fin structures 25 can be provided as one, two or more than three fin structures. One or more of the fin structures 25 may extend laterally inward to face the radome 30 (not shown).

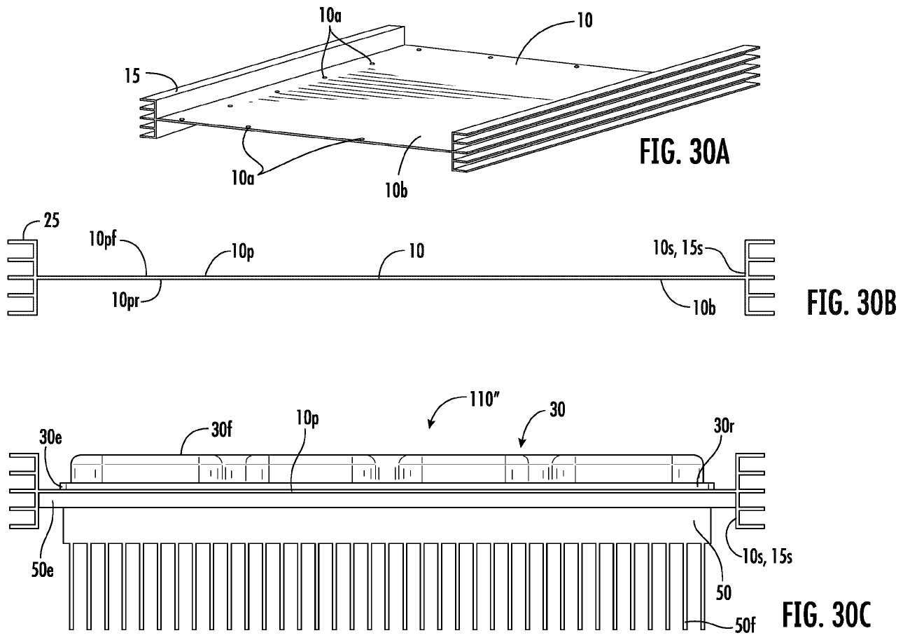

FIGS. 30A-30C show the reflector body 10b can have fin structures 25 that extend laterally outward behind the radome 30 and some that extend forward about sidewalls of the radome 30. Although shown as five parallel fin structures that turn laterally outward to face away from the radome 30, the fin structures 25 can be provided as less than or more than five fin structures. One or more of the fin structures 25 may extend laterally inward to face the radome 30 (not shown).

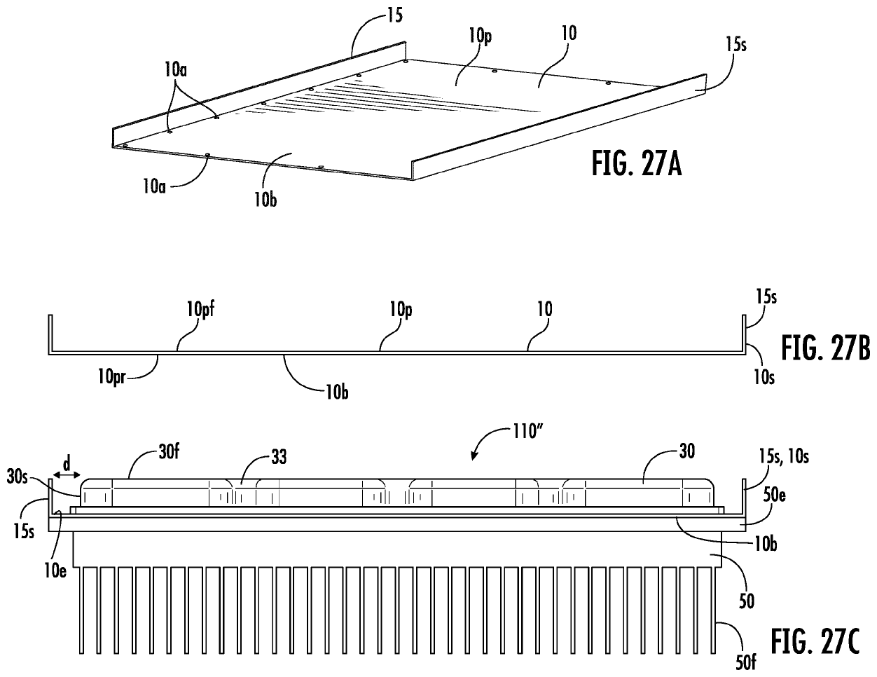

FIGS. 27A-27C illustrate that the reflector body 10b can have orthogonal bends that form the lip segments 15s that are orthogonal to the primary surface 10p of the reflector body 10b and extend forward of the primary surface 10p. FIG. 27C illustrates that the lip segment 15s can reside a distance “d” from the sidewall 30s of the reflector and the reflector body 10b can have an environmentally exposed front surface 10e between the radome sidewall 30s and lip segment 15s. The distance “d” can be in a range of 1-20 mm, in some embodiments.

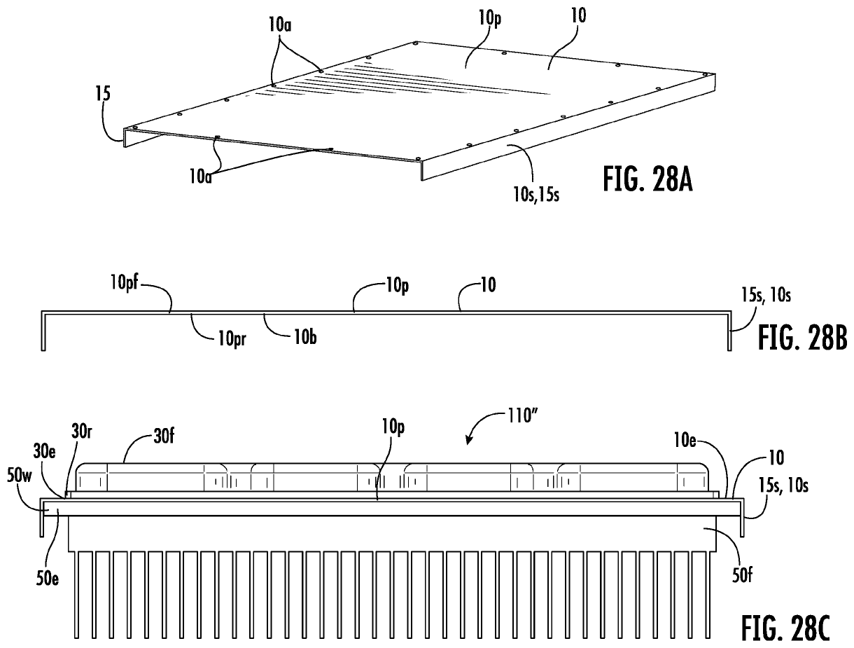

FIGS. 28A-28C illustrate that the reflector body 10b can have orthogonal bends that form the lip segments 15s that are orthogonal to the primary surface 10p of the reflector body 10b and extend rearward of the primary surface 10p. FIG. 28C illustrates that the lip segment 15s can reside a distance “d” from the sidewall 30s of the reflector and the reflector body 10b can have an environmentally exposed front primary surface 10e between the radome sidewall 30s and lip segment 15s. The distance “d” can be in a range of 1-20 mm, in some embodiments. The lip segment 15s can extend laterally outward behind the radome, then turn orthogonally rearward about an outer perimeter wall segment 50w of the planar edge 50e of the radio housing 50h.

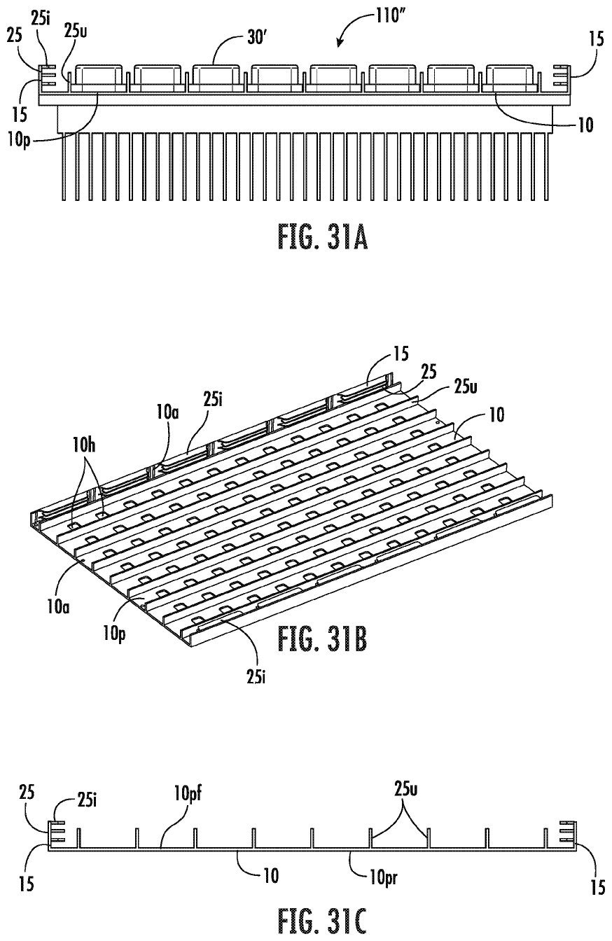

FIGS. 31A-31C illustrate that the reflector 10 can have a lip 15 that is arranged to provide heat sink structures 25 that extend laterally inwardly 25i. The lip 15 can be configured to provide sets of shaped fin structure segments that are longitudinally spaced apart along a length of the reflector 10 and that are configured to allow a channel or recess about respective apertures 10a for receiving a fixation member to extend therein.

FIGS. 31A-31C also illustrate that the reflector 10 can include forwardly extending heat sink structures 25u that project forward of the primary surface 10p of the reflector 10. The forwardly extending heat sink structures 25u can be provided without the side wall heat sink structures 25i.

FIG. 31A also illustrates that the radome 30′ can be provided as adjacent, longitudinally extending radome segments that extend between neighboring heat sink structures 25u. The primary surface 10p of the reflector body 10b may comprise a plurality of longitudinally spaced apart holes 10h between neighboring reflector heat sink structures 25u.

FIG. 31C illustrates that the inwardly extending heat sink structure 25i can have a lateral length that is less than a height of the forwardly extending heat sink structures 25u.

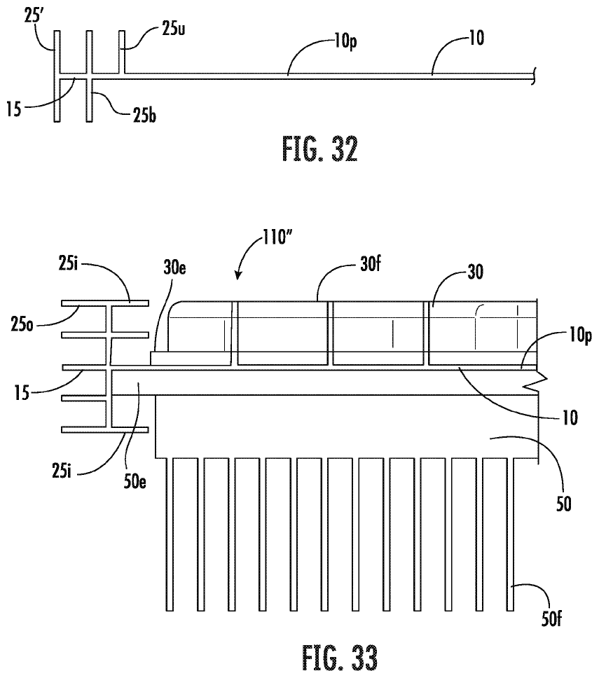

FIG. 32 illustrates that the heat sink structures 25 provided by the lip 15 of the reflector 10 can comprise at least one, shown as a plurality, of forwardly extending heat sink structures 25u and rearwardly extending heat sink structures 25b. The forwardly extending heat sink structures 25u and the rearwardly extending heat sink structures 25b can be parallel and extend only on outer perimeter side regions of the reflector 10 as shown.

FIG. 33 illustrates that the active antenna unit 110″ can comprise a reflector 10 with a lip 15 comprising at least one, shown as a plurality of, laterally, inwardly extending heat sink structures 25i and at least one, shown as a plurality of, laterally, outwardly extending heat sink structures 25o. Different numbers of the inwardly extending and outwardly extending heat sink structures may be provided. The heat sink structures 25i, 25o can be arranged so that some extend forward of the radio 50 and some extend rearward of the radome 30, 30′.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

In the discussion above, reference is made to the linear arrays of radiating elements that are commonly included in base station antennas. It will be appreciated that herein the term “linear array” is used broadly to encompass both arrays of radiating elements that include a single column of radiating elements that are configured to transmit the sub-components of an RF signal as well as to two-dimensional arrays of radiating elements (i.e., multiple linear arrays) that are configured to transmit the sub-components of an RF signal. It will also be appreciated that in some cases the radiating elements may not be disposed along a single line. For example, in some cases a linear array of radiating elements may include one or more radiating elements that are offset from a line along which the remainder of the radiating elements are aligned. This “staggering” of the radiating elements may be done to design the array to have a desired azimuth beamwidth. Such staggered arrays of radiating elements that are configured to transmit the sub-components of an RF signal are encompassed by the term “linear array” as used herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The term “about” with respect to a number, means that the stated number can vary by +/−20%.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A reflector assembly for a base station antenna, comprising:
a reflector body with an outer perimeter providing a lip that extends outward from the reflector body; and
a plurality of fin structures, stacked in a front to back direction, about the outer perimeter.

2. The reflector assembly of claim 1, wherein the reflector body comprises a front surface, wherein the lip extends laterally and/or longitudinally behind the front surface, and wherein the plurality of fin structures reside in front of the lip.

3. The reflector assembly of claim 1, wherein the reflector body is rectangular with a pair of long sides and a pair of short sides, and wherein the lip is provided as a plurality of lip segments that extend outward, at least one lip segment extending outward from each of the long sides and/or each of the short sides.

4. The reflector assembly of claim 1, wherein the lip is defined by at least one fold or bend in a segment of a sheet of metal providing the reflector body.

5. The reflector assembly of claim 4, wherein the lip comprises four lip segments, wherein neighboring end portions of at least first and second ones of the lip segments are spaced apart and define an open corner space.

6. The reflector assembly of claim 5, further comprising a coupling member extending across the open corner space.

7. The reflector assembly of claim 1, wherein at least some of the plurality of fin structures are provided by stacked sets of U-shaped channels, oriented so that an open end of the U-shaped channels faces outwardly away from the reflector body and a closed end of the U-shaped channels abuts or is in close proximity to a side wall, a top wall or a bottom wall of the reflector body.

8. The reflector assembly of claim 1, wherein at least some of the plurality of fin structures are provided by stacked sets of L-shaped channels, oriented so that a short end of the L-shaped channels abuts or is in close proximity to a side wall, a top wall or a bottom wall of the reflector body.

9. The reflector assembly of claim 1, wherein the reflector body has a pair of laterally spaced apart side walls and longitudinally spaced apart top and bottom walls, the side walls, the top wall and the bottom wall surrounding a front surface of the reflector body, and wherein the side walls, the top wall and the bottom wall extend rearwardly, in front to back direction, perpendicular to and between the lip and the front surface of the reflector body.

10. The reflector assembly of claim 9, wherein a first subset of the plurality of fin structures are affixed to the side walls, and wherein a second subset of the plurality of fin structures are affixed to the top wall or the bottom wall.

11. The reflector assembly of claim 1, wherein at least some of the plurality of fin structures are soldered, welded, brazed and/or riveted to one or more of a top wall, a bottom wall or a side wall of the reflector body, optionally wherein a dielectric gasket resides between a respective fin structure and a corresponding top wall, bottom wall or side wall.

12. The reflector assembly of claim 1, wherein the reflector body comprises a plurality of apertures, at least some of which have a lateral extent that is in a range of 20-90% of a lateral extent of the reflector body.

13. The reflector assembly of claim 12, wherein at least some of the plurality of apertures also have a longitudinal extent that is in a range of 10-60% of a longitudinal extent of the reflector body.

14. The reflector assembly of claim 1, wherein the reflector body is provided as a frame that provides the lip, wherein the reflector body is configured to cooperate with one or more substrates for defining a reflector front surface behind radiating elements and in front of a radio.

15. The reflector assembly of claim 1, wherein at least some of the plurality of fin structures are provided by an elongate channel member that is bendable or foldable to define a respective fin structure comprising first and second segments that are co-planar and orthogonal to each other whereby the bend forms a 90 degree bend joint, and wherein the first and second segments of the elongate channel extend in front of the lip.

16. The reflector assembly of claim 1, wherein the lip extends laterally outward from and perpendicular to a right side wall and a left side wall, and wherein the lip extends longitudinally from and perpendicular to a top wall and a bottom wall.

17. The reflector assembly of claim 16, wherein at least some of the plurality of fin structures are provided by an extruded or diecast member that is a discrete component from the reflector body.

18. The reflector assembly of Claim, 1, wherein at least some of the plurality of fin structures comprise a fin surface with at least one curvilinear outer facing perimeter defining a recess configured to receive a respective fixation member.

19. The reflector assembly of claim 1, wherein the reflector body and the plurality of fin structures comprise an anti-corrosion surface treatment such as galvanization and/or a coating or plating.

20. An active antenna unit, comprising:
the reflector assembly of claim 1;
a radio behind the reflector assembly;
a radio housing holding the radio; and
radiating elements in front of the reflector assembly.

21-50. (canceled)
